(19) United States
(12) Patent Application Publication
(10) Pub. No.: US 2026/0229982 A1
(43) Pub. Date: Aug. 6, 2026

(54) HYBRID BUCK-BOOST DC-DC CONVERTER WITH FLYING CAPACITOR

(71) Applicant: UNIVERSITY OF SCIENCE AND TECHNOLOGY OF CHINA, Hefei, Anhui (CN)

(72) Inventors: Lin CHENG, Hefei, Anhui (CN); Ji JIN, Hefei, Anhui (CN)

(21) Appl. No.: 19/147,155

(22) PCT Filed: Jan. 13, 2023
(86) PCT No.: PCT/CN2023/072073

§ 371 Date: Jul. 10, 2025

(51) Int. Cl. H02M 1/00; H02M 3/07; H02M 3/158

(52) U.S. Cl. CPC H02M 1/0095; H02M 1/007; H02M 3/07; H02M 3/1582

(57) ABSTRACT

The present disclosure provides a hybrid buck-boost DC-DC converter with a flying capacitor, including: an input node configured to receive an input voltage from an input voltage source; a power inductor having a terminal connected to the input node and another terminal connected to a first switch node; the flying capacitor having a terminal connected to the first switch node and another terminal connected to a second switch node; a first power switch coupled between the second switch node and ground; a second power switch coupled between the input node and the second switch node; a third power switch coupled between the first switch node and an output node; a fourth power switch coupled between the second switch node and the output node; and an output stage coupled to the output node, wherein the output stage includes an output capacitor and a load resistor.

### CROSS-REFERENCE TO RELATED APPLICATION

This application is a Section 371 National Stage Application of International Application No. PCT/CN2023/072073, filed on Jan. 13, 2023, entitled “HYBRID BUCK-BOOST DC-DC CONVERTER WITH FLYING CAPACITOR”, the content of which is hereby incorporated by reference in its entirety.

### TECHNICAL FIELD

The present disclosure relates to fields of electronic device technology and integrated circuit technology, and in particular to a hybrid buck-boost DC-DC converter with a flying capacitor.

### BACKGROUND

In a battery-powered mobile device, an actual supply voltage required by a system circuit may be greater or lower than a battery voltage. The most typical application scenario is as follows: powered by a lithium battery, a fixed 3.3 V is generated to power a system, and as usage time of the lithium battery increases, the battery voltage drops from 5 V to 2.5 V. When the battery voltage is higher than 3.3 V, a buck DC-DC converter is needed to step down the voltage. Conversely, when the battery voltage drops below 3.3 V, a boost DC-DC converter is required to step it up. In such cases, a buck-boost DC-DC converter that integrates both buck and boost functionalities offers an effective and versatile solution.

A conventional buck-boost converter cascades a conventional boost converter and a conventional buck converter. Therefore, in the power path, two power switches are always provided to be connected in series to the inductor, while a boost converter or a buck converter alone has only one power switches connected in series to the inductor. Therefore, the conventional buck-boost converter features large conduction loss. In order to improve the power efficiency, the area of the power switches needs to be increased to reduce the on-resistance of the power switches, which may undoubtedly greatly increase the manufacturing cost of the chip.

In addition, the inductor of the conventional buck-boost converter locates on the high current side in both boost mode and buck mode. In other words, the inductor current is large in both modes. In order to ensure the system efficiency, it is required to select an inductor with a small DCR (DC resistance). However, for the inductor, the smaller DCR thereof, the larger size thereof, which not only increases a volume of the chip, but also increases the cost.

### SUMMARY

The present disclosure provides a hybrid buck-boost DC-DC converter with a flying capacitor, including: an input node configured to receive an input voltage from an input voltage source; a power inductor having a terminal connected to the input node and another terminal connected to a first switch node; a flying capacitor having a terminal connected to the first switch node and another terminal connected to a second switch node; a first power switch coupled between the second switch node and ground; a second power switch coupled between the input node and the second switch node; a third power switch coupled between the first switch node and an output node; a fourth power switch coupled between the second switch node and the output node; and an output stage coupled to the output node, the output stage including an output capacitor and a load resistor connected in parallel, and configured to provide a load current based on an output voltage at the output node.

According to embodiments of the present disclosure, when the input voltage is higher than the output voltage, the converter operates in a buck mode, and when the input voltage is lower than the output voltage, the converter operates in a boost mode.

According to embodiments of the present disclosure, in the boost mode, the fourth power switch remains turned off. The boost mode includes a first state and a second state, according to an interlocking configuration of the first power switch, the second power switch and the third power switch.

According to embodiments of the present disclosure, in the first state, the first power switch is turned on, while the second power switch and the third power switch are turned off. During the first state, the voltage of the first switch node is lower than the input voltage, indicating a voltage across the power inductor is positive, so that the power inductor is magnetized, and a current of the power inductor increases and charges the flying capacitor.

According to embodiments of the present disclosure, in the second state, the first power switch is turned off, while the second power switch and the third power switch are turned on. During the second state, the voltage of the first switch node is the same as output voltage which is higher than input voltage, and the voltage of the second switch node is equal to the input voltage. The voltage across the inductor is negative, so that the power inductor is demagnetized, a current of the power inductor decreases, and the flying capacitor is discharged.

According to embodiments of the present disclosure, in the buck mode, the second power switch remains turned off, and the buck mode includes a third state and a fourth state, according to an interlocking configuration of the first power switch, the third power switch and the fourth power switch.

According to embodiments of the present disclosure, in the third state, the first power switch and the third power switch are turned on, while the fourth power switch is turned off. During the third state, a voltage of the first switch node is equal to the output voltage, and a voltage of the second switch node is zero. The voltage at the first switch node is lower than the input voltage, a voltage across the power inductor is positive, so that the power inductor is magnetized, a current of the power inductor increases, the flying capacitor is discharged, and energy flows into the output capacitor.

According to embodiments of the present disclosure, in the fourth state, the first power switch and the third power switch are turned off, while the fourth power switch is turned on. The voltage at the first switch node reaches twice the output voltage, and the voltage at the second switch node is equal to the output voltage. The voltage at the first switch node exceeds the input voltage, the voltage across the power inductor is negative, so that the power inductor is demagnetized, a current of the power inductor decreases, and the flying capacitor is charged.

According to embodiments of the present disclosure, in the boost mode, the current of the power inductor is equal to the load current; the first power switch, the second power switch, and the third power switch are selected to have a maximum voltage rating equal to the input voltage, and the fourth power switch is selected to have a maximum voltage rating equal to the output voltage.

According to embodiments of the present disclosure, in the buck mode, the current of the power inductor is lower than the load current, the first power switch, the third power switch and the fourth power switch are selected to have a maximum voltage rating equal to the output voltage, and the second power switch is selected to have a maximum voltage rating equal to the input voltage.

### BRIEF DESCRIPTION OF THE DRAWINGS

FIG. 1a is a schematic diagram of a conventional buck-boost converter.

FIG. 1b is a schematic diagram of the conventional buck-boost converter shown in FIG. 1a operating in buck mode.

FIG. 1c is a schematic diagram of the conventional buck-boost converter shown in FIG. 1a operating in boost mode.

FIG. 2a illustrates the main waveforms of the conventional buck-boost converter shown in FIG. 1a in buck mode.

FIG. 2b illustrates the main waveforms of the conventional buck-boost converter shown in FIG. 1a in boost mode.

FIG. 3a is a schematic diagram of a buck-boost converter with a flying capacitor in the prior art.

FIG. 3b is a schematic diagram of the buck-boost converter of FIG. 3a operating in buck mode.

FIG. 3c is a schematic diagram of the buck-boost converter of FIG. 3a operating in boost mode.

FIG. 4a illustrates the main waveforms of the buck-boost converter of FIG. 3a in buck mode.

FIG. 4b illustrates the main waveforms of the buck-boost converter of FIG. 3a in boost mode.

FIG. 5 is a schematic diagram of a hybrid buck-boost DC-DC converter with a flying capacitor according to embodiments of the present disclosure.

FIG. 6a is a schematic diagram of the first state of the hybrid buck-boost of FIG. 5 operating in boost mode.

FIG. 6b is a schematic diagram of the second state of the hybrid buck-boost of in FIG. 5 operating in boost mode.

FIG. 7 illustrates the main waveforms of the hybrid buck-boost DC-DC converter operating in boost mode according to embodiments of the present disclosure.

FIG. 8a is a schematic diagram of the third state of the hybrid buck-boost DC-DC converter of FIG. 5 operating in buck mode.

FIG. 8b is a schematic diagram of the fourth state of the hybrid buck-boost DC-DC converter of FIG. 5 operating in buck mode.

FIG. 9 illustrates the main waveforms of the hybrid buck-boost DC-DC converter operating in buck mode according to embodiments of the present disclosure.

FIG. 10 is a schematic diagram of the working process of a hybrid buck-boost DC-DC converter with a flying capacitor according to embodiments of the present disclosure.

### DETAILED DESCRIPTION OF EMBODIMENTS

The present disclosure provides a hybrid buck-boost DC-DC converter with a flying capacitor, which is a novel hybrid buck-boost DC-DC converter topological structure. On the basis of a conventional buck-boost converter, a flying capacitor is introduced, which may assist an inductor to charge an output in both a boost mode and a buck mode, thereby reducing an inductor current. Moreover, while reducing the inductor current, a current on each power switch may also be reduced, and a conduction loss of the power switch may also be reduced, without introducing a voltage rating problem.

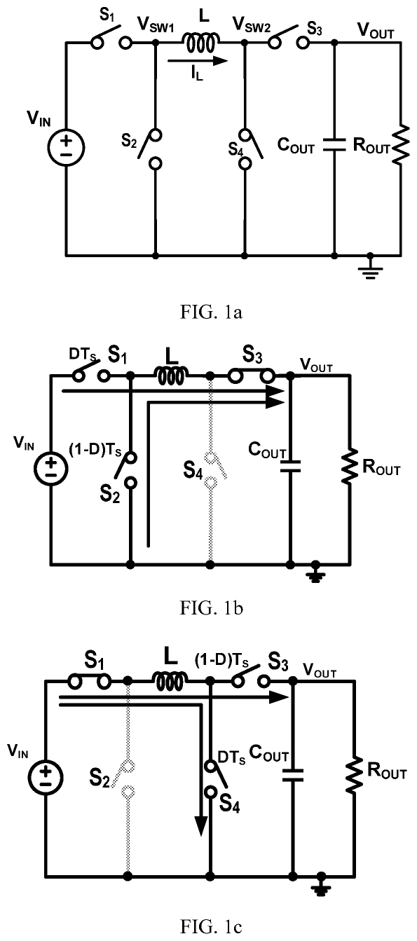

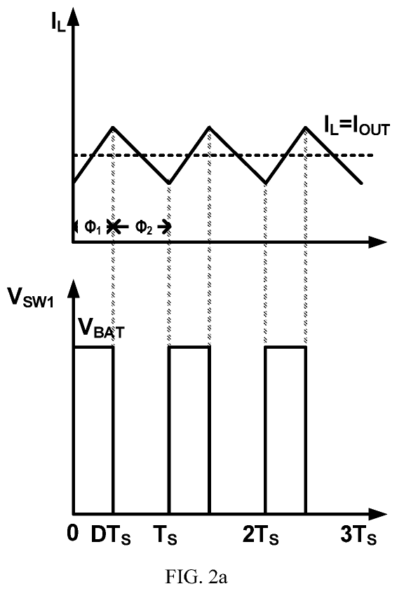

A conventional buck-boost converter is shown in FIG. 1a. The converter structure includes four power switches S₁, S₂, S₃, S₄, a power inductor L, an output capacitor C_{OUT}, and a load resistor R_{OUT}. The circuit has two working modes as follows.

When an input voltage is higher than an output voltage (V_{IN}>V_{OUT}), as shown in FIG. 1b, a circuit operates in a buck mode. A working principle thereof is similar to a working principle of a conventional buck converter. The two power switches S₁ and S₂ are alternately turned on, S₃ remains turned on, and a switch node V_{SW1} switches between V_{IN} and 0. Relationships among a voltage conversion ratio M (M=V_{OUT}/V_{IN}), an average current of the power inductor, and a duty cycle D are:

$$M = D \qquad ( 1 )$$

$${I}_{L} = {I}_{OUT} \qquad ( 2 )$$

Where, D∈(0,1), M∈(0,1), I_{L} is a current of the power inductor, and I_{OUT} is an output current, or a load current of the load resistor R_{OUT}.

When the input voltage is lower than the output voltage (V_{IN}<V_{OUT}), as shown in FIG. 1c, the circuit operates in a boost mode. A working principle thereof is similar to a working principle of a conventional boost converter. The two power switches S₃ and S₄ are alternately turned on, S₁ remains turned on, and a second switch node V_{SW2} switches between V_{OUT} and 0. Relationships among the voltage conversion ratio M (M=V_{OUT}/V_{IN}), an average inductor current, and the duty cycle D are:

$$M = 1 / ( 1 - D ) \qquad ( 3 )$$

$${I}_{L} = {MI}_{OUT} \qquad ( 4 )$$

Where, D∈(0,1), M∈(1, ∞).

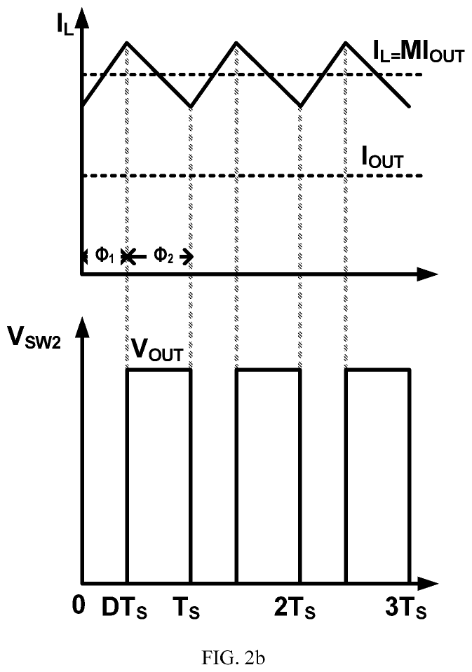

Main waveforms of the circuit are shown in FIG. 2a and FIG. 2b. From the above-mentioned analysis, it can be seen that in the buck or boost mode of the conventional buck-boost converter, the power switch S₁ or the power switch S₃ remains turned on, which may greatly increase a conduction loss of the system. In order to reduce the conduction loss, a size of the switch must be increased to obtain a lower on-resistance, which may increase a chip manufacturing cost. At the same time, in the buck or boost mode of the conventional buck-boost converter, the inductor current is very large. In order to reduce a loss on an inductor, an inductor with a smaller DCR must be selected. The smaller the DCR, the larger a size of the inductor. This may not only increase a cost, but also increase a volume of the chip.

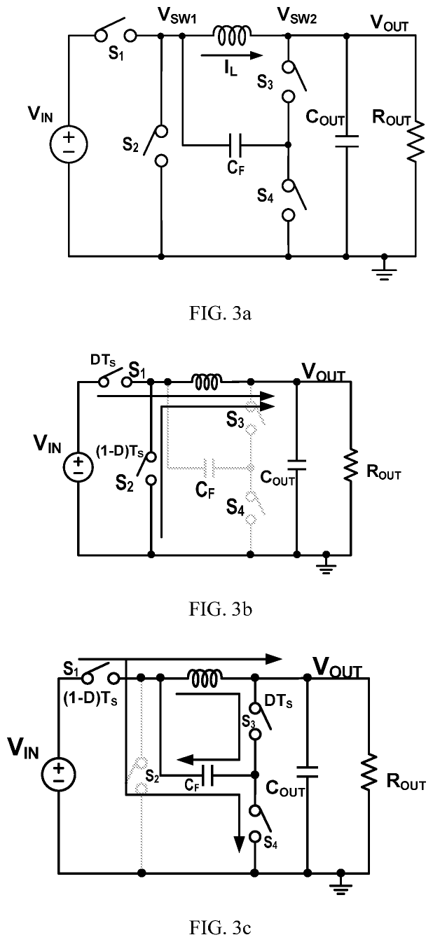

In order to reduce the conduction loss, ISSCC2017 proposed a novel topological structure, as shown in FIG. 3a. The structure includes four switches, including a power inductor L, a flying capacitor C_{F}, an output capacitor C_{OUT}, and a load resistor R_{OUT}.

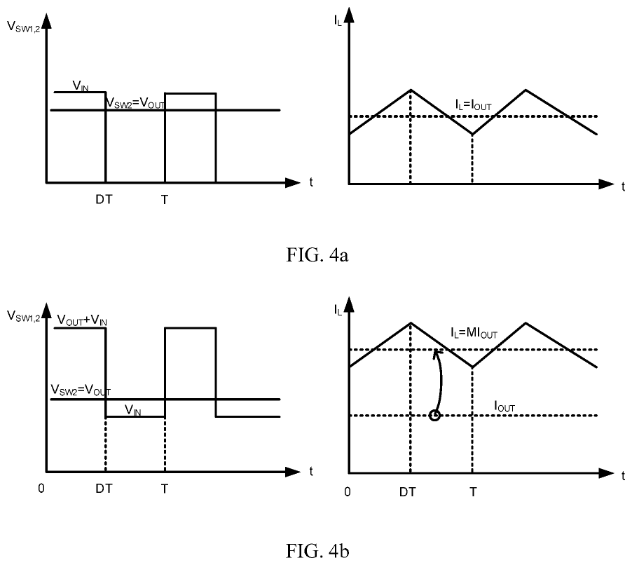

Similarly, when the input voltage is higher than the output voltage (V_{IN}>V_{OUT}), the circuit operates in a buck mode, as shown in FIG. 3b. In the buck mode, just like a conventional buck converter, only two switches S₁ and S₂ are alternately turned on, the switch node switches between V_{IN} and 0, and S₃ and S₄ remain turned off. No charging or discharging process is provided on the flying capacitor. Compared with the conventional buck-boost converter, one less power switch that remains turned on is provided in the power path, which may greatly reduce a conduction loss of the circuit. In the buck mode:

$$M = D \qquad ( 5 )$$

$${I}_{L} = {I}_{OUT} \qquad ( 6 )$$

Where, D∈(0,1), M∈(0,1). The main waveform diagram of the circuit in the buck mode is shown in FIG. 4a.

When the input voltage is lower than the output voltage (V_{IN}<V_{OUT}), the circuit operates in a boost mode, as shown in FIG. 3c. In the circuit, S₁, S₃ and S₄ operate, and S₂ remains turned off. During a period of DT to T, S₁ and S₄ are turned on, and the flying capacitor is charged, the switch node V_{SW1} equals to V_{IN}, a voltage value V_{SW2} of the second switch node equals to V_{OUT}, V_{OUT} is lower than V_{IN}, a voltage difference V_{SW1}-V_{SW2} between both terminals of the power inductor is lower than 0, and the inductor is demagnetized. At this time, a voltage V_{CF} between both terminals the flying capacitor equals to V_{IN}. During a period of 0 to DT, S₁ and S₄ are turned off, and S₃ is turned on. Since the voltage between both terminals of the flying capacitor may not change suddenly, a voltage value V_{SW1} of the first switch node equals to V_{OUT}+V_{CF}=V_{IN}+V_{OUT}, the voltage value V_{SW2} of the second switch node equals to V_{OUT}, where V_{SW1}-V_{SW2}>0, the voltage across the power inductor is positive, and the inductor is magnetized. Unfortunately, a voltage stress on S₁ is V_{IN}+V_{OUT} at this time. Therefore, S₁ requires a power switch with a higher voltage withstand capability, which means an increase in a chip area and a manufacturing cost. In the boost mode:

$$M = 1 / ( 1 - D ) \qquad ( 7 )$$

$${I}_{L} = {MI}_{OUT} \qquad ( 8 )$$

Where, D∈(0,1), M∈(1, ∞). The average inductor current is higher than the load current. The main waveform of the circuit in the boost mode is shown in FIG. 4b.

As can be seen from the above, the conventional buck-boost converter shown in FIG. 1a requires three switches in both the boost mode and the buck mode, and is provided with a power switch that remains turned on, resulting in a very large conduction loss. In order to realize a high efficiency, a power switch with a larger area must be used, which may increase a chip area and a chip manufacturing cost. In addition, the inductor current is very large in both the boost mode and the buck mode. In order to realize the high efficiency, an inductor with a smaller DCR must be used. The inductor with a small DCR may have a larger size, which may increase a cost and an overall volume of the chip. The buck-boost converter with a flying capacitor shown in FIG. 3a has only two power switches operating in the buck mode and three power switches operating in the boost mode. However, unlike a conventional structure, there is no power switch that remains turned on. Therefore, in general, the conduction loss of the power switch may be reduced compared to the conventional structure. However, S₁ requires a power switch with a high voltage withstand capability, which may increase the chip area and the chip manufacturing cost, thereby reducing a system efficiency.

In addition, the inductor currents of these two structures are very large in both the boost mode and the buck mode, and thus a large-sized inductor is required. At the same time, a large inductor current also means a large conduction loss of the power switch.

In view of the above-mentioned problems, an objective of the present disclosure is to propose a novel buck-boost converter topological structure, which may reduce an inductor current in both the boost mode and the buck mode, reduce a conduction loss of the power switch and a loss of the inductor DCR, without introducing any voltage withstand problem of the power switch. In this way, a high efficiency may be realized while greatly reducing a cost and a volume of the chip.

In order to make the objective, the technical solutions and the advantages of the present disclosure clearer, the present disclosure will be further described in detail below with reference to specific embodiments and the accompanying drawings.

In embodiments of the present disclosure, a hybrid buck-boost DC-DC converter with a flying capacitor is provided. As shown in FIG. 5, the hybrid buck-boost DC-DC converter with a flying capacitor includes:
an input node configured to receive an input voltage V_{IN} from an input voltage source;
a power inductor L having a terminal connected to the input node and another terminal connected to a first switch node V_{SW1};
the flying capacitor C_{F} having a terminal connected to the first switch node V_{SW1}, and another terminal connected to a second switch node V_{SW2};
a first power switch S₁ coupled between the second switch node V_{SW1} and ground;
a second power switch S₂ coupled between the input node and the second switch node V_{SW2};
a third power switch S₃ coupled between the first switch node V_{SW1} and an output node, where the output node is configured to send out an output voltage V_{OUT};
a fourth power switch S₄ coupled between the second switch node V_{SW2} and the output node; and
an output stage coupled to the output node, wherein the output stage includes an output capacitor C_{OUT} and a load resistor R_{OUT} connected in parallel, and is configured to provide a load current based on an output voltage at the output node.

When the input voltage is higher than the output voltage, the converter operates in the buck mode, and when the input voltage is lower than the output voltage, the converter operates in the boost mode. In the boost mode, the fourth power switch remains turned off, and the boost mode includes a first state and a second state, according to an interlocking configuration of the first power switch, the second power switch and the third power switch. In the buck mode, the second power switch remains turned off, the buck mode includes a third state and a fourth state, according to an interlocking configuration of the first power switch, the third power switch and the fourth power switch.

In an embodiment of the present disclosure, when the input voltage is lower than the output voltage (V_{IN}<V_{OUT}), the circuit operates in the boost mode. In the boost mode, the fourth power switch S₄ remains turned off, S₁, S₂ and S₃ are alternately turned on, and the voltage V_{CF} between both terminals of the flying capacitor equals to V_{OUT}-V_{IN}.

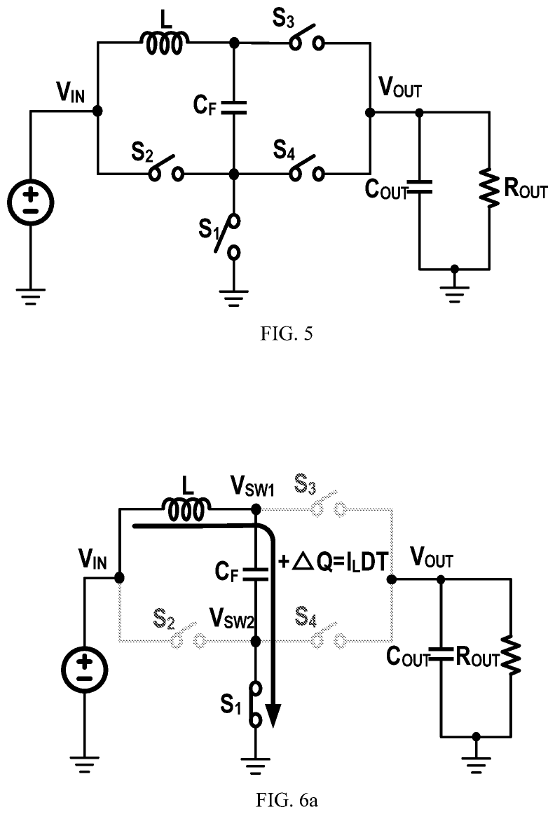

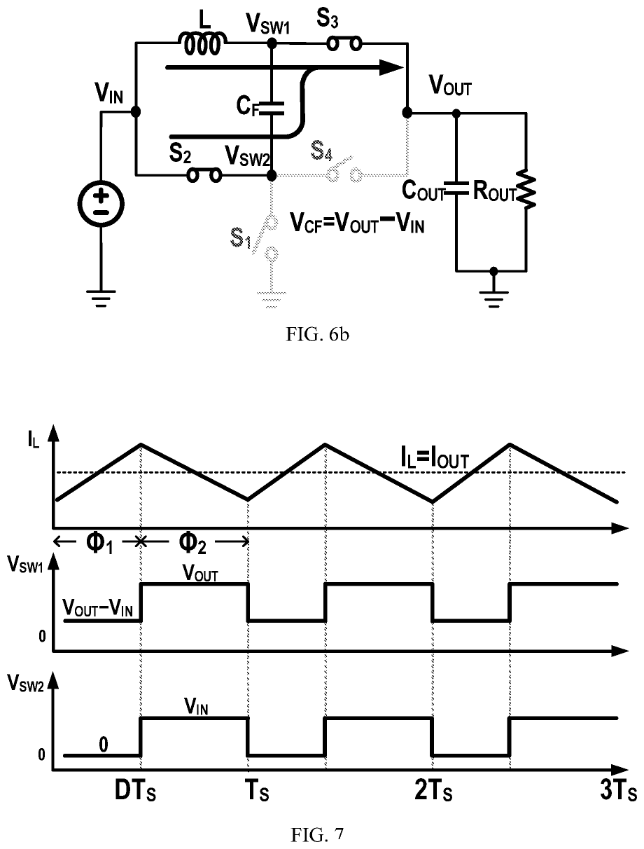

More specifically, in combination with FIG. 6a, FIG. 7 and FIG. 10, during a period of the first state (0 to DT) of the boost mode, S₁ is turned on, and S₂ and S₃ are turned off. At this time, a voltage value V_{SW1} of the first switch node equals to V_{OUT}-V_{IN}, a voltage value V_{SW2} of the second switch node equals to 0, V_{SW1} is lower than the input voltage V_{IN}, a voltage across the power inductor is positive, the inductor is magnetized, a current of the inductor rises and charges the flying capacitor. During the period, no energy flows from an input to the output capacitor.

More specifically, in combination with FIG. 6b, FIG. 7 and FIG. 10, during a period of the second state (DT to T), S₁ is turned off, and S₂ and S₃ are turned on. At this time, a voltage value V_{SW1} of the first switch node equals to V_{OUT}, V_{SW2} equals to V_{IN}, V_{SW1} is higher than the input voltage V_{IN}, a voltage across the power inductor is negative, the inductor is demagnetized, and a current of the inductor drops. At this time, the flying capacitor is discharged to transfer energy to the output capacitor C_{OUT}. By performing a volt-second balance on the inductor, it may be obtained:

$$D ( {V}_{IN} - ( {V}_{OUT} - {V}_{IN} ) ) = ( 1 - D ) ( {V}_{OUT} - {V}_{IN} ) \qquad ( 9 )$$

$$M = \frac{{V}_{OUT}}{{V}_{IN}} = 1 + D \qquad ( 10 )$$

Where, M is a voltage conversion ratio, D is a duty cycle, D∈(0,1), M∈(1,2), V_{IN} is a voltage value of the input voltage, and V_{OUT} is a voltage value of the output voltage.

In the boost mode, a key signal waveform is shown in FIG. 7. A current I_{L} of the power inductor equals to I_{OUT}, and is lower than MI_{OUT} (M>1) in a conventional structure. In the boost mode, the current of the power inductor is equal to the load current. The first power switch S₁, the second power switch S₂ and the third power switch S₃ are selected to have a maximum voltage rating equal to the input voltage, and the fourth power switch S₄ is selected to have a maximum voltage rating equal to the output voltage. For example, a range of the input voltage is 2.5 V to 5 V, and a range of the output voltage is 3.3±0.1V.

In an embodiment of the present disclosure, when the input voltage is higher than the output voltage (V_{IN}>V_{OUT}), the circuit operates in the buck mode. In the buck mode, S₂ remains turned off, S₁, S₃ and S₄ are alternately turned on, and the voltage V_{CF} between both terminals of the flying capacitor equals to V_{OUT}.

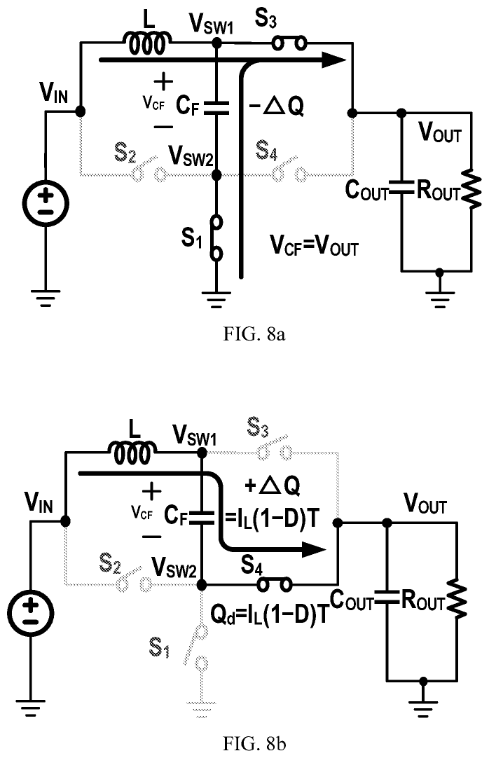

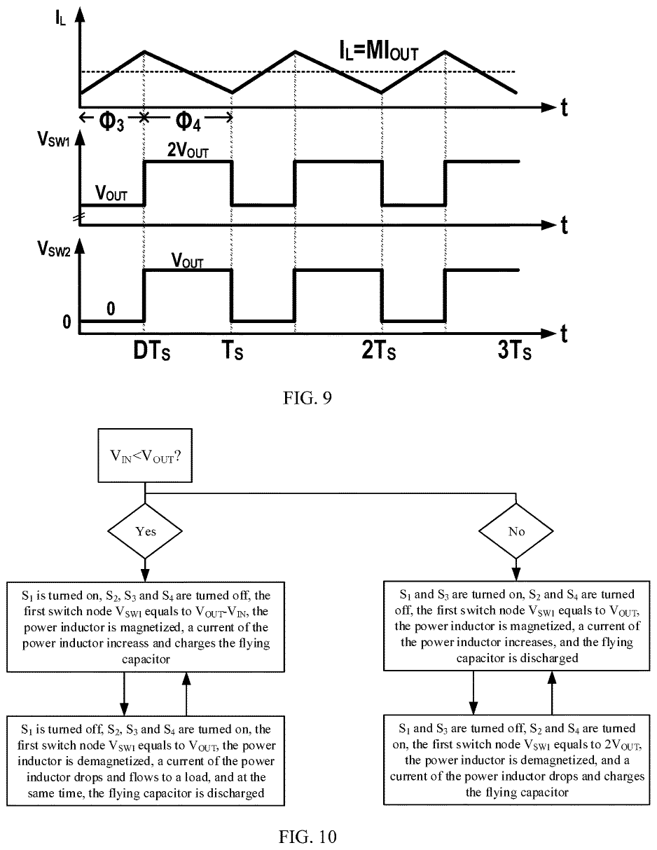

More specifically, in combination with FIG. 8a, FIG. 9 and FIG. 10, during a period of the third state (0 to DT) of the buck mode, S₁ and S₃ are turned on, and S₄ is turned off. At this time, the switch node V_{SW1} equals to V_{OUT}, V_{SW2} equals to 0, V_{SW1} is lower than the input voltage V_{IN}, a voltage across the power inductor is positive, the inductor is magnetized, and a current of the inductor rises. At this time, the flying capacitor is discharged, and energy flows to the output capacitor C_{OUT}.

More specifically, in combination with FIG. 8b, FIG. 9 and FIG. 10, during a period of the fourth state (DT to T), S₁ and S₃ are turned off, and S₄ is turned on. At this time, the switch node V_{SW1} equals to 2V_{OUT}, V_{SW2} equals to V_{OUT}, V_{SW1} is higher than the input voltage V_{IN}, voltage across the power inductor is negative, the inductor is demagnetized, and a current of the inductor drops. At this time, the flying capacitor is charged. By performing a volt-second balance on the inductor, it may be obtained:

$$D ( {V}_{IN} - {V}_{OUT} ) = ( 1 - D ) ( 2 {V}_{OUT} - {V}_{IN} ) \qquad ( 11 )$$

$$M = \frac{{V}_{OUT}}{{V}_{IN}} = \frac{1}{2 - D} \qquad ( 12 )$$

Where, M is a voltage conversion ratio, D is a duty cycle, D∈(0, 1), M∈(0.5, 1), V_{IN} is a voltage value of the input voltage, and V_{OUT} is a voltage value of the output voltage.

In the buck mode, a main signal waveform of the circuit is shown in FIG. 9, and the current I_{L} of the inductor equals to MI_{OUT} (M<1), and is lower than I_{OUT} in a conventional structure. In the buck mode, the current of the power inductor is lower than the load current, and the first power switch S₁, the third power switch S₃ and the fourth power switch S₄ are selected to have a maximum voltage rating equal to the output voltage, and the second power switch S₂ is selected to have a maximum voltage rating equal to the input voltage. For example, a range of the input voltage is 2.5 V to 5 V, and a range of the output voltage is 3.3±0.1 V.

So far, embodiments of the present disclosure have been described in detail with reference to the accompanying drawings. It should be noted that the implementation methods not shown or described in the accompanying drawings or the text of the specification are all forms known to those skilled in the art and are not described in detail. In addition, the above-mentioned definitions of the elements and methods are not limited to the various specific structures, shapes or methods mentioned in the embodiments, and they may be simply modified or replaced by those skilled in the art.

According to the above-mentioned description, those skilled in the art should have a clear understanding of the hybrid buck-boost DC-DC converter with a flying capacitors in the present disclosure.

In summary, the present disclosure provides a hybrid buck-boost DC-DC converter with a flying capacitor. On the basis of four power switches and one power switch of the conventional structure, a flying capacitor is introduced, which may greatly reduce a conduction loss of the power switch while reducing a current of the inductor under all working conditions. Under a premise of ensuring a high system efficiency, a chip area and an inductor size may be greatly reduced, and a cost and a volume of the chip may be reduced.

The hybrid buck-boost DC-DC converter with a flying capacitor in the present disclosure has at least one or part of the following advantages: (1) a current on the inductor may be reduced in both the buck mode and the boost mode, thereby ensuring a high efficiency; (2) under a premise of ensuring the high efficiency, an inductor with a larger DCR may be selected, and a size of the inductor may be reduced; (3) while reducing an inductor current, a current on each power switch may also be reduced, and a conduction loss of the power switch may be greatly reduced; (4) the power switch in the system is a power switch having a maximum voltage rating equal to V_{IN} (5V) or a similar voltage rating, a switch with a high voltage rating capability is not required. Under a premise of ensuring a high efficiency of the system, a size of the power switch may be reduced, thereby saving a chip area and reducing a chip manufacturing cost.

The above are specific embodiments of the present disclosure, and do not constitute a limitation on the scope of protection of the present disclosure. Any other corresponding changes and modifications made according to the technical concept of the present disclosure shall be included in the scope of protection of the claims of the present disclosure.

1. A hybrid buck-boost DC-DC converter with a flying capacitor, comprising:
an input node configured to receive an input voltage from an input voltage source;
a power inductor having a terminal connected to the input node and another terminal connected to a first switch node,
wherein the flying capacitor has a terminal connected to the first switch node and another terminal connected to a second switch node;
a first power switch coupled between the second switch node and ground;
a second power switch coupled between the input node and the second switch node;
a third power switch coupled between the first switch node and an output node;
a fourth power switch coupled between the second switch node and the output node; and
an output stage coupled to the output node, wherein the output stage comprises an output capacitor and a load resistor connected in parallel, and is configured to provide a load current based on an output voltage at the output node.

2. The hybrid buck-boost DC-DC converter with a flying capacitor according to claim 1, wherein when the input voltage is higher than the output voltage, the converter operates in a buck mode, and when the input voltage is lower than the output voltage, the converter operates in a boost mode.

3. The hybrid buck-boost DC-DC converter with a flying capacitor according to claim 2, wherein in the boost mode, the fourth power switch remains turned off, and the boost mode comprises a first state and a second state, according to an interlocking configuration of the first power switch, the second power switch and the third power switch.

4. The hybrid buck-boost DC-DC converter with a flying capacitor according to claim 3, wherein in the first state, the first power switch is turned on, while the second power switch and the third power switch are turned off, and
wherein during the first state, a voltage of the first switch node is lower than the input voltage, indicating a voltage across the power inductor is positive, so that the power inductor is magnetized, and a current of the power inductor increases and charges the flying capacitor.

5. The hybrid buck-boost DC-DC converter with a flying capacitor according to claim 3, wherein in the second state, the first power switch is turned off, while the second power switch and the third power switch are turned on,
wherein during the second state, the voltage of the first switch node is same as output voltage which is higher than input voltage, and a voltage of the second switch node is equal to the input voltage, a voltage across the power inductor is negative, so that the power inductor is demagnetized, a current of the power inductor decreases, and the flying capacitor is discharged.

6. The hybrid buck-boost DC-DC converter with a flying capacitor according to claim 2, wherein in the buck mode, the second power switch remains turned off, and the buck mode comprises a third state and a fourth state, according to an interlocking configuration of the first power switch, the third power switch and the fourth power switch.

7. The hybrid buck-boost DC-DC converter with a flying capacitor according to claim 6, wherein in the third state, the first power switch and the third power switch are turned on, while fourth power switch is turned off,
wherein during the third state, a voltage of the first switch node is equal to the output voltage, a voltage of the second switch node is zero, the voltage of the first switch node is lower than the input voltage, a voltage across the power inductor is positive, so that the power inductor is magnetized, a current of the power inductor increases, the flying capacitor is discharged, and energy flows into the output capacitor.

8. The hybrid buck-boost DC-DC converter with a flying capacitor according to claim 6, wherein in the fourth state, the first power switch and the third power switch are turned off, while fourth power switch is turned on, a voltage at the first switch node reaches twice the output voltage, a voltage of the second switch node is equal to the output voltage, the voltage at the first switch node exceeds the input voltage, the voltage across the power inductor is negative, so that the power inductor is demagnetized, a current of the power inductor decreases, and the flying capacitor is charged.

9. The hybrid buck-boost DC-DC converter with a flying capacitor according to claim 2, wherein in the boost mode, the current of the power inductor is equal to the load current, the first power switch, the second power switch, and the third power switch are selected to have a maximum voltage rating equal to the input voltage, and the fourth power switch is selected to have a maximum voltage rating equal to the output voltage.

10. The hybrid buck-boost DC-DC converter with a flying capacitor according to claim 2, wherein in the buck mode, the current of the power inductor is lower than the load current, the first power switch, the third power switch and the fourth power switch are selected to have a maximum voltage rating equal to the output voltage, and the second power switch is selected to have a maximum voltage rating equal to the input voltage.
